(19) United States
(12) Patent Application Publication
(10) Pub. No.: US 2006/0139324 A1
(43) Pub. Date: Jun. 29, 2006

(54) Display and remote controller

(75) Inventor: Yet-Zen Lin, Taipei City (TW)

Correspondence Address: BACON & THOMAS, PLLC, 625 SLATERS LANE, FOURTH FLOOR, ALEXANDRIA, VA, 22314, US

(73) Assignee: Tatung Co., Ltd., Taipei City (TW)

(21) Appl. No.: 11/201,244

(22) Filed: Aug. 11, 2005

(30) Foreign Application Priority Data
Dec. 23, 2004 (TW) 093140294

(51) Int. Cl. G09G 5/08

(52) U.S. Cl. 345/158

(57) ABSTRACT

The invention is related to a display with remote control, includes a display and a remote control. The user can wirelessly transfer a cursor-shifting signal to the display via remote control, process decoding via cursor-shifting circuit, and display the correspondent shifting movement of the cursor on the display. Therefore, the user of the present invention only needs one remote control to acquire the functions of controller and cursor operation simultaneously to reduce the inconvenience of requiring both devices at the same time.

### BACKGROUND OF THE INVENTION

1. Field of the Invention

The invention is related to a display with remote control; more particularly one control that comprises the function of a mouse and by which may transfer the cursor-shifting signal to the display to be displayed.

2. Description of Related Art

The advancement of technology along with time has always motivated the industrial environment and inspired demand and growth of the market. Moreover, the development of high-tech industry promotes the expansion of television and display industries. Therefore, television has become one of the essential electric appliances of every household and the one with the highest utility rate. Along with the generalization of the Internet, to integrate personal computer and television has become one of the important design principals for home use televisions.

After the integration of traditional television and personal computer, to acquire the function of simultaneous use of computer and television, it is required to have the wireless remote control and mouse respectively to control the television and computer. It was unable to combine the remote control and mouse in the same device. Not only this causes trouble in use, but the problem of easy loss of devices due to inability for integration also causes the user trouble in application.

Therefore, it is desirable to provide an improved speech recognition method to mitigate and/or obviate the aforementioned problems.

### SUMMARY OF THE INVENTION

A display with remote control according to the present invention comprises a display and a remote control. The display includes a display screen, at least one signal receiver, a decoder, an IR receiver, a speaker, and a microprocessor. The microprocessor respectively electrically connects to the display screen, the at least one signal receiver, the decoder, the IR receiver, and the speaker. The at least one signal receiver receives an externally inputted synchronizing signal, the microprocessor fetches the synchronizing signal from the at least one signal receiver, and controls the decoder to decode the synchronizing signal, so as to display accordingly on the display screen and to broadcast accordingly from the speaker. The remote control includes an IR transmitter, a key set, an encoder, and a microprocessor. The microprocessor respectively electrically connects to the IR transmitter, the key set and the encoder. The key set comprises a plurality of keys respectively outputting a plurality of corresponding control signals, the microprocessor fetches the control signals, and controls the encoder to encode the control signals, so as to transmit accordingly by the IR transmitter. Wherein, the remote control further comprises a cursor device electrically connecting to the microprocessor. The cursor device outputs a cursor-shifting signal, and the microprocessor fetches the cursor-shifting signal, and controls the encoder to encode the cursor-shifting signal, so as to transmit accordingly by the IR transmitter. In addition, the display further comprises a cursor-shifting decoding circuit, the IR receiver of the display wirelessly receives the cursor-shifting signal from the remote control. The microprocessor of the display fetches the cursor-shifting signal, transfers the cursor-shifting signal to the cursor-shifting decoding circuit for decoding, and controls a cursor on the display screen to phase shift accordingly. Therefore, the use of present invention makes it possible to acquire the functions of a remote control and cursor operation simultaneously. The invention solves user's problem of requiring both devices and greatly increases the convenience of application.

Moreover, the cursor device can be composed of at least one key of the key set, the remote control can be further comprised a shifting circuit for controlling the at least one key to selectively output one of the following: the control signal and the cursor shifting signal. The shifting circuit can be comprised a shifting button. The IR transmitter can be comprised an LED. The display screen can be an LCD screen. The at least one signal receiver can be comprised a TV signal receiver. The cursor device can be a directional key unit.

Other objects, advantages, and novel features of the invention will become more apparent from the following detailed description when taken in conjunction with the accompanying drawings.

### BRIEF DESCRIPTION OF THE DRAWINGS

FIG. 1 is the function block diagram of preferred embodiment according to the invention.

FIG. 2 is the operation diagram of preferred embodiment according to the invention.

FIG. 3 is the function block diagram of another preferred embodiment according to the invention.

### DETAILED DESCRIPTION OF THE PREFERRED EMBODIMENT

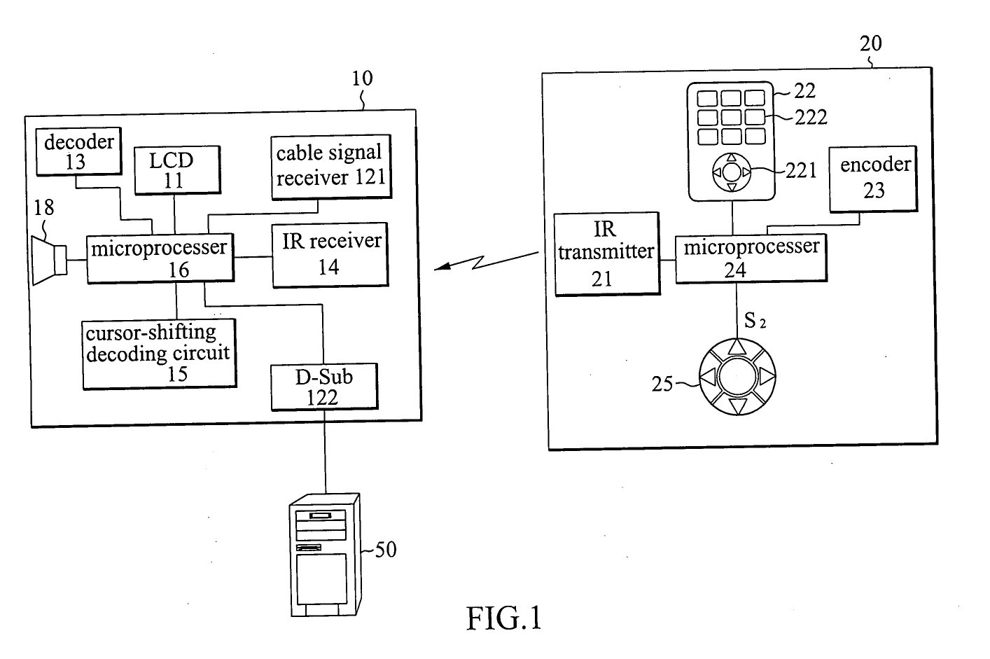

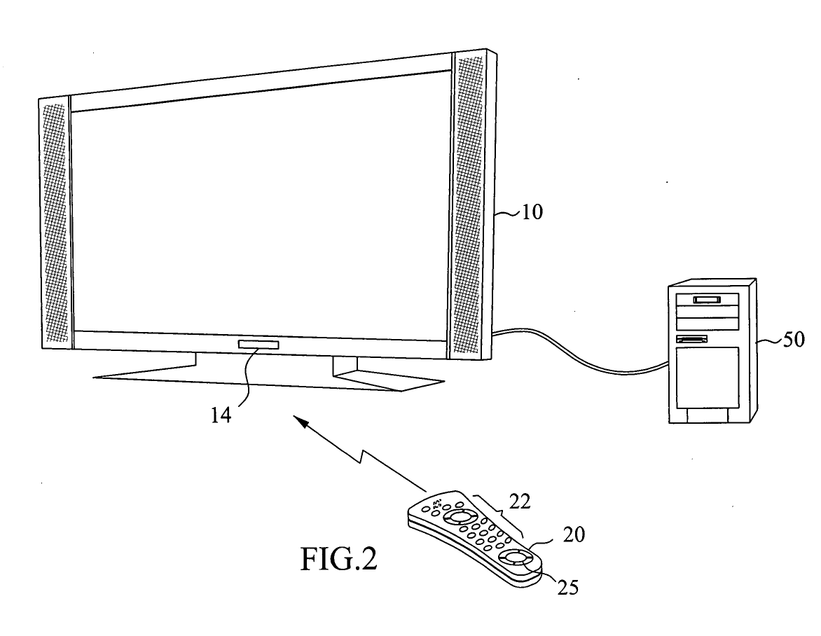

Please refer to the system block diagram of FIG. 1 and operation diagram of FIG. 2 for the preferred embodiment of a display with remote control according to the present invention. In the embodiment, display 10 comprises a LCD 11, a cable signal receiver 121, a decoder 13, an IR receiver 14, a speaker 18, and a microprocessor 16. The microprocessor 16 respectively electrically connects to the LCD 11, the cable signal receiver 121, the decoder 13, the IR receiver 14, and the speaker 18. The cable signal receiver 121 receives visual synchronizing signal inputted from an external device. The microprocessor 16 fetches visual synchronizing signal received by cable signal receiver 121, controls the decoder 13 to decode the visual synchronizing signal, controls the LCD 11 to display the decoded signal, and controls the speaker 18 to broadcast. In this particular embodiment, display 10 not only can receive visual synchronizing signal via cable signal receiver 121, it can also connects to a mainframe 50 through a D-sub connecting hub and receive synchronizing signal inputted by the mainframe 50.

As shown in FIG. 1, remote control 20 includes an IR transmitter 21, a key set 22, an encoder 23, and a microprocessor 24. The microprocessor 24 further electrically connects to the IR transmitter 21, the key set 22, and the encoder 23. In this embodiment, the IR transmitter 21 is a Light-Emitting Diode (LED). Moreover, the key set 22 comprises a browse key 221, and a plurality of control keys 222 that respectively output a plurality of differentiated control signals. The microprocessor 24 fetches the plurality of differentiated control signals, controls the encoder 23 to encode received control signals, and controls the IR transmitter 21 to output the encoded signals.

The characteristic of the present invention is that the remote control 20 comprises a cursor device 25, which electrically connects to the microprocessor 24. The cursor device 25 outputs a cursor-shifting signal to the microprocessor 24 to further control the encoder 23 to process encoding and control the IR transmitter 21 to transfer the signal to the display 10. Moreover, the display 10 comprises a cursor-shifting decoding circuit 15. When the IR receiver 14 of the display 10 receives the cursor-shifting signal from the remote control 20 wirelessly, the microprocessor 16 of the display 10 fetches the cursor-shifting signal, transfers it to the cursor-shifting decoding circuit 15 to proceed decoding, and controls a cursor on the display screen 11 to phase shift accordingly. In this particular embodiment, the cursor device 25 can also be device with the same function such as touchpad other than keystroke.

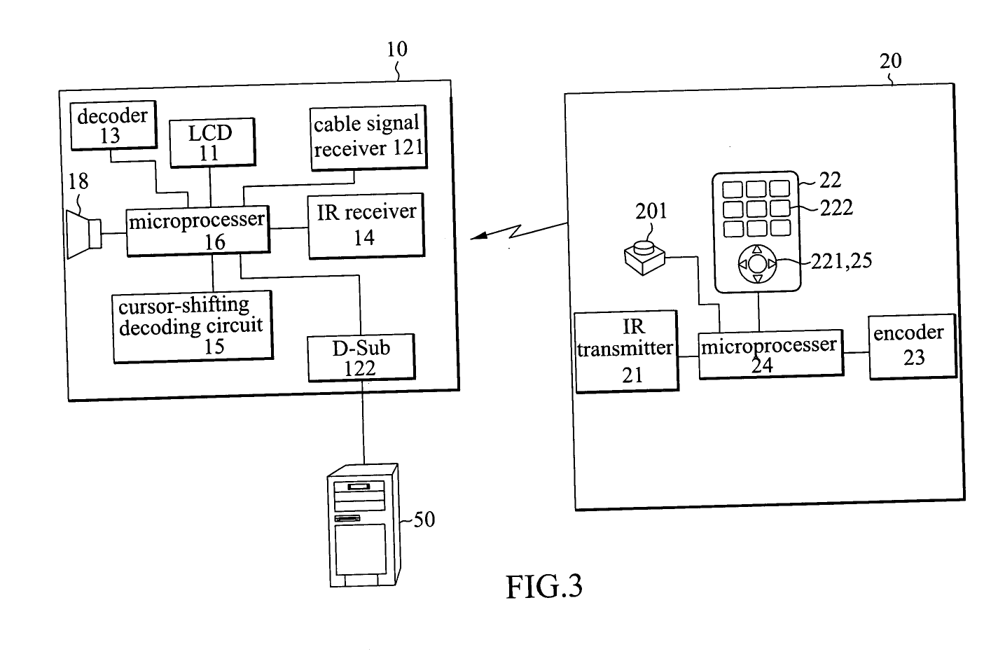

FIG. 3 is function block diagram of another preferred embodiment according to the invention. It mainly uses browse key 221 of the key set 22 to replace the function of the cursor device 25. As shown in FIG. 3, the cursor device 25 is formed by the browse key 221 of the key set 22. Remote control 20 further comprises a shifting circuit 201. In this particular embodiment, shifting circuit 201 is a shifting button, used to control and shift browse key 221 to output one of the following: the control signal and the cursor shifting signal.

As stated above, the present invention allows the user to avoid the necessity to have both remote control and mouse to operate the functions of television and computer. Integrating the functions of remote control and mouse, the present invention truly greatly increases the convenience of application. Other than the advantage of ease of carrying, the invention also reduces the expense for the hardware consumption.

Although the present invention has been explained in relation to its preferred embodiment, it is to be understood that many other possible modifications and variations can be made without departing from the spirit and scope of the invention as hereinafter claimed.

What is claimed is:

1. A display with remote control, comprising:
a display, including a display screen, at least one signal receiver, a decoder, an IR receiver, a speaker, and a microprocessor, said microprocessor respectively electrically connects to said display screen, said at least one signal receiver, said decoder, said IR receiver, and said speaker, said at least one signal receiver receives an externally inputted synchronizing signal, said microprocessor fetches said synchronizing signal from said at least one signal receiver, and controls said decoder to decode said synchronizing signal, so as to display accordingly on said display screen and to broadcast accordingly from said speaker; and
a remote control, including an IR transmitter, a key set, an encoder, and a microprocessor, said microprocessor respectively electrically connects to said IR transmitter, said key set and said encoder, said key set comprises a plurality of keys respectively outputting a plurality of corresponding control signals, said microprocessor fetches said control signals, and controls said encoder to encode said control signals, so as to transmit accordingly by said IR transmitter;
wherein, said remote control further comprises a cursor device electrically connecting to said microprocessor, said cursor device outputs a cursor-shifting signal, said microprocessor fetches the cursor-shifting signal, and controls said encoder to encode the cursor-shifting signal, so as to transmit accordingly by said IR transmitter;
wherein, said display further comprises a cursor-shifting decoding circuit, the IR receiver of said display wirelessly receives the cursor-shifting signal from said remote control, the microprocessor of said display fetches said cursor-shifting signal, transfers said cursor-shifting signal to said cursor-shifting decoding circuit for decoding, and controls a cursor on said display screen to phase shift accordingly.

2. The display with remote control as claimed in claim 1, wherein said cursor device is composed of at least one key of said key set, said remote control further comprises a shifting circuit for controlling the at least one key to selectively output one of the following: said control signal and said cursor shifting signal.

3. The display with remote control as claimed in claim 2, wherein said shifting circuit comprises a shifting button.

4. The display with remote control as claimed in claim 1, wherein said IR transmitter comprises an LED.

5. The display with remote control as claimed in claim 1, wherein said display screen is an LCD screen.

6. The display with remote control as claimed in claim 1, wherein said at least one signal receiver comprises a TV signal receiver.

7. The display with remote control as claimed in claim 1, wherein said cursor device is a directional key unit.
